(19) United States
(12) Patent Application Publication
(10) Pub. No.: US 2025/0284928 A1
(43) Pub. Date: Sep. 11, 2025

(54) SYSTEM AND METHOD FOR TARGETED SYNTHETIC DATA EXTRACTION AND ANALYSIS VIA A MULTI-MODAL NEURAL NETWORK

(71) Applicant: BANK OF AMERICA CORPORATION, Charlotte, NC (US)

(72) Inventors: Shailendra Singh, Thane West (IN); Shreya Manocha, Gurugram (IN); Saurabh Gupta, Dwarka (IN)

(73) Assignee: BANK OF AMERICA CORPORATION, Charlotte, NC (US)

(21) Appl. No.: 18/597,088

(22) Filed: Mar. 6, 2024

(51) Int. Cl. G06N 3/045

(52) U.S. Cl. CPC G06N 3/045

(57) ABSTRACT

Systems, computer program products, and methods are described herein for targeted synthetic data extraction and analysis via a multi-modal neural network. The present disclosure includes transmitting a training data request for synthetic data with a requirements payload having a plurality of rules via a smart contract. Upon a condition where a first rule is satisfied, first compliant synthetic data may be input to a first primary neural network. Upon a condition where a second rule is satisfied, second compliant synthetic data may be input to a second primary neural network. A first secondary neural network may receive the outputs of the first and second primary neural networks to determine one or more aggregate preferred synthetic data sources.

### TECHNOLOGICAL FIELD

Example implementations of the present disclosure relate to a system and method for targeted synthetic data extraction and analysis via a multi-modal neural network.

### BACKGROUND

With the growth of AI and ML technologies, organizations are increasingly reliant on feeding accurate and diverse training data into machine learning applications. The demand for comprehensive datasets is paramount. To facilitate certain analyses, machine learning systems require extensive test data. However, as the reliance on machine learning and AI intensifies, organizations are turning to synthetic test data generation methods to fulfill these requirements. Synthetic data, though not derived from real-world observations, mimics the characteristics of genuine data.

Yet, the advent of synthetic test data introduces a complex challenge involving bias. Synthetic data generation processes may inadvertently perpetuate and amplify inherent biases present in the original datasets. Consequently, machine learning models trained on such biased datasets may produce skewed outcomes, reinforcing societal biases. Moreover, certain groups may be misrepresented or underrepresented in synthetic datasets, diminishing the model's ability to make unbiased decisions. Recognizing bias as dynamic and context-dependent, it becomes evident that synthetic data may struggle to capture the evolving nature of biases, posing a challenge in anticipating and mitigating such biases in AI and ML systems over time.

### BRIEF SUMMARY

Systems, methods, and computer program products are provided for targeted synthetic data extraction and analysis via a multi-modal neural network.

In one aspect, a system for targeted synthetic data extraction and analysis via a multi-modal neural network is presented. The system may include a processing device, a non-transitory storage device containing instructions when executed by the processing device, causes the processing device to perform the steps of: transmit a training data request for training a machine learning model to a plurality of synthetic data sources, wherein the training data request may include a requirements payload for synthetic data, the requirements payload may include a plurality of rules via a smart contract, wherein the plurality of rules may include a first rule and a second rule, retrieve, upon a condition where the first rule is satisfied by at least one first compliant synthetic data source, first compliant synthetic data from the at least one first compliant synthetic data source, input, to a first primary neural network of at least one primary neural network, the first compliant synthetic data and the at least one first compliant synthetic data source, determine, via the first primary neural network and based on the first rule, a first preferred synthetic data source corresponding to a first preferred synthetic data, retrieve, upon a condition where the second rule is satisfied by at least one second compliant synthetic data source, second compliant synthetic data from the at least one second compliant synthetic data source, input, to a second primary neural network of the at least one primary neural network, the second compliant synthetic data and the at least one second compliant synthetic data source, determine, via the second primary neural network and based on the second rule, a second preferred synthetic data source corresponding to a second preferred synthetic data, input, to a first secondary neural network of at least one secondary neural network, the first preferred synthetic data, the second preferred synthetic data, the first preferred synthetic data source, and the second preferred synthetic data source, and determine, via the first secondary neural network, one or more aggregate preferred synthetic data sources corresponding to an aggregate preferred synthetic data.

In some implementations, the instructions may further cause the processing device to perform the steps of retrieve, continuously at a predetermined interval, a subsequent first compliant synthetic data from at least one subsequent first compliant synthetic data source, and a subsequent second compliant synthetic data from at least one subsequent second compliant synthetic data source, wherein the first rule of the plurality of rules is satisfied by the at least one subsequent first compliant synthetic data source, and wherein the second rule of the plurality of rules is satisfied by the at least one subsequent second compliant synthetic data source, input, continuously at the predetermined interval, the subsequent first compliant synthetic data and the at least one subsequent first compliant synthetic data source into the first primary neural network, and the subsequent second compliant synthetic data and the at least one subsequent second compliant synthetic data source into the second primary neural network, determine, via the first primary neural network and the second primary neural network, continuously at a predetermined interval, a subsequent first preferred synthetic data source and a subsequent second preferred synthetic data source, and determine, via the first secondary neural network, one or more subsequent aggregate preferred synthetic data sources corresponding to a subsequent aggregate preferred synthetic data.

In some implementations, the instructions may further cause the processing device to perform the steps of determine a first variance between the aggregate preferred synthetic data and non-synthetic real-word data.

In some implementations, the instructions may further cause the processing device to perform the steps of determine a first variance between the aggregate preferred synthetic data and non-synthetic real-word data, determine a second variance between the subsequent aggregate preferred synthetic data and the non-synthetic real-word data, and determine a variance drift between first variance and the second variance.

In some implementations, the plurality of rules may include at least one selected from the group consisting of synthetic data temporal information, synthetic data geolocation, synthesizing algorithm name, and synthesizing algorithm version.

In some implementations, the plurality of rules may include a target variance from non-synthetic real-world data.

In some implementations, the smart contract is self-executing and resides on a blockchain.

In another aspect, a computer program product for targeted synthetic data extraction and analysis via a multi-modal neural network is presented. The computer program product may include a non-transitory computer-readable medium having code causing an apparatus to transmit a training data request for training a machine learning model to a plurality of synthetic data sources, wherein the training data request may include a requirements payload for synthetic data, the requirements payload having a plurality of rules via a smart contract, wherein the plurality of rules may include a first rule and a second rule, retrieve, upon a condition where the first rule is satisfied by at least one first compliant synthetic data source, first compliant synthetic data from the at least one first compliant synthetic data source, input, to a first primary neural network of at least one primary neural network, the first compliant synthetic data and the at least one first compliant synthetic data source, determine, via the first primary neural network and based on the first rule, a first preferred synthetic data source corresponding to a first preferred synthetic data, retrieve, upon a condition where the second rule is satisfied by at least one second compliant synthetic data source, second compliant synthetic data from the at least one second compliant synthetic data source, input, to a second primary neural network of the at least one primary neural network, the second compliant synthetic data and the at least one second compliant synthetic data source, determine, via the second primary neural network and based on the second rule, a second preferred synthetic data source corresponding to a second preferred synthetic data, input, to a first secondary neural network of at least one secondary neural network, the first preferred synthetic data, the second preferred synthetic data, the first preferred synthetic data source, and the second preferred synthetic data source, and

determine, via the first secondary neural network, one or more aggregate preferred synthetic data sources corresponding to an aggregate preferred synthetic data.

In some implementations, the code may further cause the apparatus to retrieve, continuously at a predetermined interval, a subsequent first compliant synthetic data from at least one subsequent first compliant synthetic data source, and a subsequent second compliant synthetic data from at least one subsequent second compliant synthetic data source, wherein the first rule of the plurality of rules is satisfied by the at least one subsequent first compliant synthetic data source, and wherein the second rule of the plurality of rules is satisfied by the at least one subsequent second compliant synthetic data source, input, continuously at the predetermined interval, the subsequent first compliant synthetic data and the at least one subsequent first compliant synthetic data source into the first primary neural network, and the subsequent second compliant synthetic data and the at least one subsequent second compliant synthetic data source into the second primary neural network, determine, via the first primary neural network and the second primary neural network, continuously at a predetermined interval, a subsequent first preferred synthetic data source and a subsequent second preferred synthetic data source, and determine, via the first secondary neural network, one or more subsequent aggregate preferred synthetic data sources corresponding to a subsequent aggregate preferred synthetic data.

In some implementations, the code may further cause the apparatus to determine a first variance between the aggregate preferred synthetic data and non-synthetic real-word data.

In some implementations, the code may further cause the apparatus to determine a first variance between the aggregate preferred synthetic data and non-synthetic real-word data, determine a second variance between the subsequent aggregate preferred synthetic data and the non-synthetic real-word data, and determine a variance drift between first variance and the second variance.

In some implementations, the plurality of rules may include at least one selected from the group consisting of synthetic data temporal information, synthetic data geolocation, synthesizing algorithm name, and synthesizing algorithm version.

In some implementations, the plurality of rules may include a target variance from non-synthetic real-world data.

In some implementations, the smart contract is self-executing and resides on a blockchain.

In yet another aspect, a method for targeted synthetic data extraction and analysis via a multi-modal neural network is presented. The method may include transmitting a training data request for training a machine learning model to a plurality of synthetic data sources, wherein the training data request may include a requirements payload for synthetic data, the requirements payload having a plurality of rules via a smart contract, wherein the plurality of rules may include a first rule and a second rule, retrieving, upon a condition where the first rule is satisfied by at least one first compliant synthetic data source, first compliant synthetic data from the at least one first compliant synthetic data source, inputting, to a first primary neural network of at least one primary neural network, the first compliant synthetic data and the at least one first compliant synthetic data source, determining, via the first primary neural network and based on the first rule, a first preferred synthetic data source corresponding to a first preferred synthetic data, retrieving, upon a condition where the second rule is satisfied by at least one second compliant synthetic data source, second compliant synthetic data from the at least one second compliant synthetic data source, inputting, to a second primary neural network of the at least one primary neural network, the second compliant synthetic data and the at least one second compliant synthetic data source, determining, via the second primary neural network and based on the second rule, a second preferred synthetic data source corresponding to a second preferred synthetic data, inputting, to a first secondary neural network of at least one secondary neural network, the first preferred synthetic data, the second preferred synthetic data, the first preferred synthetic data source, and the second preferred synthetic data source, and determining, via the first secondary neural network, one or more aggregate preferred synthetic data sources corresponding to an aggregate preferred synthetic data.

In some implementations, the method may further include retrieving, continuously at a predetermined interval, a subsequent first compliant synthetic data from at least one subsequent first compliant synthetic data source, and a subsequent second compliant synthetic data from at least one subsequent second compliant synthetic data source, wherein the first rule of the plurality of rules is satisfied by the at least one subsequent first compliant synthetic data source, and wherein the second rule of the plurality of rules is satisfied by the at least one subsequent second compliant synthetic data source, inputting, continuously at the predetermined interval, the subsequent first compliant synthetic data and the at least one subsequent first compliant synthetic data source into the first primary neural network, and the subsequent second compliant synthetic data and the at least one subsequent second compliant synthetic data source into the second primary neural network, determining, via the first primary neural network and the second primary neural network, continuously at a predetermined interval, a subsequent first preferred synthetic data source and a subsequent second preferred synthetic data source, and determining, via the first secondary neural network, one or more subsequent aggregate preferred synthetic data sources corresponding to a subsequent aggregate preferred synthetic data.

In some implementations, the method may further include determining a first variance between the aggregate preferred synthetic data and non-synthetic real-word data.

In some implementations, the method may further include determining a first variance between the aggregate preferred synthetic data and non-synthetic real-word data, determining a second variance between the subsequent aggregate preferred synthetic data and the non-synthetic real-word data, and determining a variance drift between first variance and the second variance.

In some implementations, the plurality of rules may include at least one selected from the group consisting of synthetic data temporal information, synthetic data geolocation, synthesizing algorithm name, and synthesizing algorithm version.

In some implementations, the plurality of rules may include a target variance from non-synthetic real-world data.

The above summary is provided merely for purposes of summarizing some example implementations to provide a basic understanding of some aspects of the present disclosure. Accordingly, it will be appreciated that the above-described implementations are merely examples and should not be construed to narrow the scope or spirit of the disclosure in any way. It will be appreciated that the scope of the present disclosure encompasses many potential implementations in addition to those here summarized, some of which will be further described below.

### BRIEF DESCRIPTION OF THE DRAWINGS

Having thus described implementations of the disclosure in general terms, reference will now be made the accompanying drawings. The components illustrated in the Figures may or may not be present in certain implementations described herein. Some implementations may include fewer (or more) components than those shown in the Figures.

FIGS. 1A-1C illustrates technical components of an exemplary distributed computing environment for targeted synthetic data extraction and analysis via a multi-modal neural network, in accordance with an implementation of the disclosure;

FIGS. 2A-2B illustrate an exemplary distributed ledger technology (DLT) architecture, in accordance with an implementation of the disclosure;

FIG. 3 illustrates an exemplary neural network subsystem architecture, in accordance with an implementation of the disclosure;

FIG. 4 illustrates a process flow for targeted synthetic data extraction and analysis via a multi-modal neural network, in accordance with an implementation of the disclosure;

FIG. 5 illustrates a flowchart for targeted synthetic data extraction and analysis via a multi-modal neural network, in accordance with an implementation of the disclosure; and

FIG. 6 illustrates a network diagram of neural network layers of a multimodal neural network, in accordance with some implementations of the disclosure.

### DETAILED DESCRIPTION

Implementations of the present disclosure will now be described more fully hereinafter with reference to the accompanying drawings, in which some, but not all, implementations of the disclosure are shown. Indeed, the disclosure may be embodied in many different forms and should not be construed as limited to the implementations set forth herein; rather, these implementations are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some implementations, the user may be an individual having past relationships, current relationships or potential future relationships with an entity. In some implementations, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, “synthetic data” or “synthetic training data” may refer to artificially generated data that mimics real-world data but is created through various algorithms or computational models rather than collected directly from observations or measurements. This generated data may be utilized for training machine learning models, testing algorithms, or augmenting existing datasets to improve model performance without the need for costly or time-consuming data collection processes. Additionally, synthetic data may encompass a wide range of formats, including images, text, audio, and structured data, tailored to suit the specific requirements of the intended application or domain.

The increasing reliance on AI and ML technologies has led organizations to seek comprehensive datasets for training and testing machine learning applications. However, as this demand grows, organizations are exploring synthetic test data generation methods to augment their datasets. Synthetic data, while mimicking genuine data characteristics, introduces a significant challenge: bias. Unlike real-world observations, synthetic data may inadvertently perpetuate and amplify biases present in the original datasets used for training.

Current solutions to address bias in synthetic test data involve various mitigation techniques, such as algorithmic adjustments or diversity-aware data generation methods. However, these approaches often fall short in fully eliminating bias due to the dynamic and context-dependent nature of biases. Moreover, certain groups may still be misrepresented or underrepresented in synthetic datasets, compromising the model's ability to make unbiased decisions. There is a pressing need for a technical solution that can effectively anticipate and mitigate biases in synthetic test data generation processes. This solution should incorporate advanced algorithms capable of dynamically adapting to evolving biases and ensuring diverse representation across groups. By addressing bias in synthetic data generation, organizations can enhance the fairness of their machine learning models, thus promoting more equitable outcomes in AI-driven decision-making processes.

Addressing these challenges necessitates the establishment of a system and method for targeted synthetic data extraction and analysis via a multi-modal neural network. Such a framework allows for the determination of the adherence to specific rules surrounding synthetic data that may be set forth by an entity. As such, an entity may ensure that the synthetic data used, which often originates from third-party vendors, complies with strict anti-bias standards. To do so, potential synthetic data sources and their provided data may also be characterized in and quantified by comparison to the real-world data which the synthetic data is purported to represent. By further tracking this comparison over time, so-called bias “drift” (i.e., the shifting of datasets in small increments over time that may slowly and inadvertently introduce biases) may be detected and avoided.

Accordingly, the solution to the aforementioned shortcomings is presented herein and implements a methodology for entities to evaluate the quality of the synthetic data available to the entity from multiple different sources, and provides for a framework to select the source of the synthetic data based on predetermined rules and the output of a multi-modal neural network comprised of a plurality of neural networks. In utilizing such a framework, the factors and rules set forth for decision-making, as well as the adherence to such rules by the various synthetic data sources, are recorded in a distributed ledger (e.g., blockchain) for future traceability should the source of the data and the decision-making methods ever be questioned by regulators or otherwise.

Indeed, the present disclosure includes a system, computer program product, and method that embrace the transmitting of training data requests from an entity to multiple synthetic data sources. This training data request may include one or more smart contracts containing multiple rules pertaining to the needs of the synthetic data. Examples of such rules include, but are not limited to, synthetic data temporal information, synthetic data geolocation, synthesizing algorithm name, synthesizing algorithm version, and/or a target variance from non-synthetic real-world data.

When a rule is satisfied, the synthetic data compliant with the rule and the information pertaining to the source of the synthetic data are retrieved. These may be input into a unimodal neural network specific to that rule. From this unimodal neural network, a preferred source of the synthetic data is determined. This is repeated for each rule, with each rule having its own unimodal neural network associated with the rule, and where each rule may correspond to different or identical synthetic data and/or synthetic data sources, such that multiple preferred synthetic data sources are identified across the multiple unimodal neural networks. Having a hierarchy such that another neural network receives the outputs from each of the unimodal neural networks, a multimodal neural network is formed such that a neural network at a higher layer (i.e. a secondary neural network, tertiary neural network, and so forth) determines an overall synthetic data source and synthetic data best suited for the use of the entity. What's more, other layers of neural networks may be implemented to further granularize the decision-making of each neural network and ultimately arrive at a more suitable outcome. A variance between the identified synthetic data and the real-world data of which it represents may be calculated as one output of the process.

The process may be repeated at a predetermined time interval, such that the process is ongoing, and the entity receives consistent feedback into whether the choice of synthetic data and synthetic data source are still aligned with the objectives of the entity. Each time, or at another predetermined time interval, the variance between the synthetic data and the real-world data of which it represents may be calculated as an output. Over time, these variances may be compared to one another to determine if any variance drift (i.e., creep) exists that may otherwise go unnoticed.

What is more, the present disclosure provides a technical solution to a technical problem. As described herein, the technical problem includes the need for effective solutions to anticipate and mitigate biases in synthetic data generation processes used for training and testing machine learning applications. The technical solution presented herein allows for the leveraging of rules in smart contracts on a distributed ledger to feed neural networks that assist in identifying the optimal synthetic data source(s). The present disclosure embraces an improvement over existing solutions to tracking, screening, and procuring synthetic data (i) with fewer steps to achieve the solution, thus reducing the amount of network resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving network resources, (iv) determining an optimal amount of resources that need to be used to implement the solution, thus reducing network traffic and load on existing network resources. Furthermore, the technical solution described herein uses a rigorous, computerized process to perform specific tasks and/or activities that were not previously performed. In specific implementations, the technical solution bypasses a series of steps previously implemented, thus further conserving network resources.

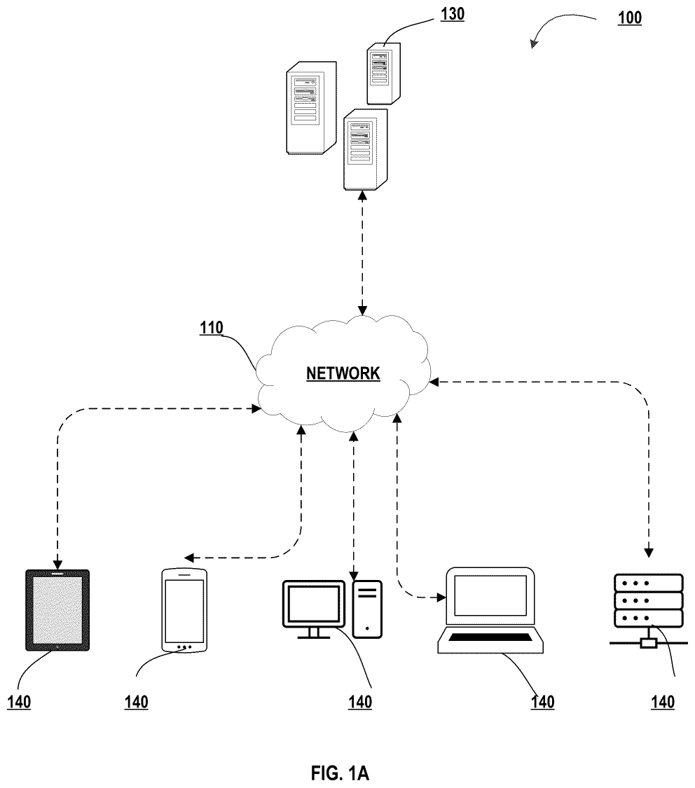

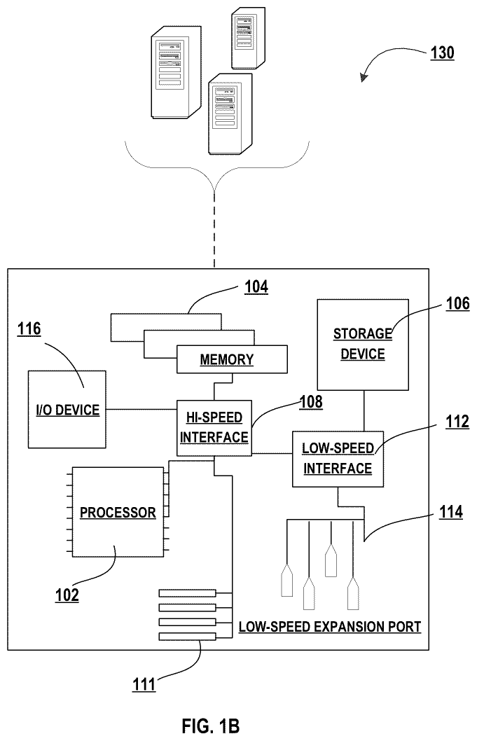

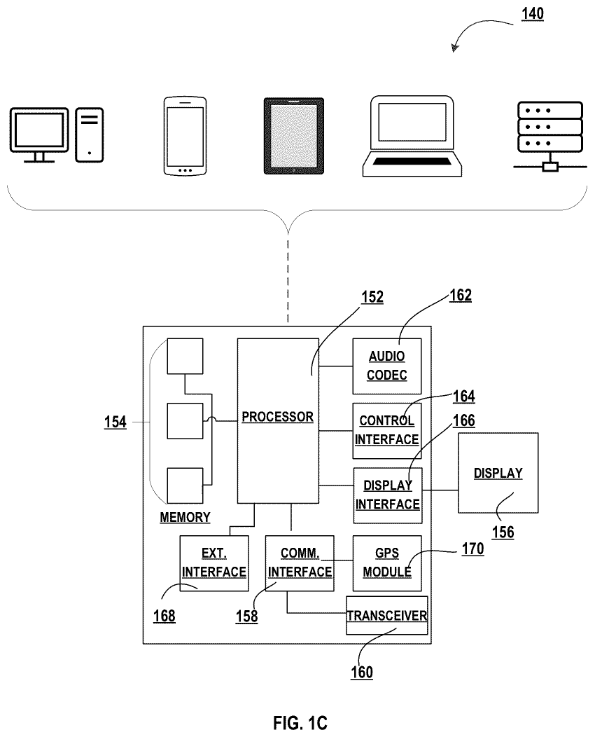

FIGS. 1A-1C illustrate technical components of an exemplary distributed computing environment 100 for targeted synthetic data extraction and analysis via a multi-modal neural network, in accordance with an implementation of the disclosure. As shown in FIG. 1A, the distributed computing environment 100 contemplated herein may include a system 130, an endpoint device(s) 140, and a network 110 over which the system 130 and endpoint device(s) 140 communicate therebetween. FIG. 1A illustrates only one example of an implementation of the distributed computing environment 100, and it will be appreciated that in other implementations one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some implementations, the system 130 and the endpoint device(s) 140 may have a client-server relationship in which the endpoint device(s) 140 are remote devices that request and receive service from a centralized server, i.e., the system 130. In some other implementations, the system 130 and the endpoint device(s) 140 may have a peer-to-peer relationship in which the system 130 and the endpoint device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The endpoint device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. In addition to shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an implementation of the disclosure. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 connecting to low speed bus 114 and storage device 106. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 106, or memory on processor 102.

The high-speed interface 108 manages bandwidth-intensive operations for the system 130, while the low speed controller 112 manages lower bandwidth-intensive operations. Such allocation of functions is exemplary only. In some implementations, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the endpoint device(s) 140, in accordance with an implementation of the disclosure. As shown in FIG. 1C, the endpoint device(s) 140 includes a processor 152, memory 154, an input/output device such as a display 156, a communication interface 158, and a transceiver 160, among other components. The endpoint device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the endpoint device(s) 140, including instructions stored in the memory 154, which in one implementation includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the endpoint device(s) 140, such as control of user interfaces, applications run by endpoint device(s) 140, and wireless communication by endpoint device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of endpoint device(s) 140 with other devices. External interface 168 may provide, for example, for wired communication in some implementations, or for wireless communication in other implementations, and multiple interfaces may also be used.

The memory 154 stores information within the endpoint device(s) 140. The memory 154 can be implemented as one or more of a computer-readable medium or media, a volatile memory unit or units, or a non-volatile memory unit or units. Expansion memory may also be provided and connected to endpoint device(s) 140 through an expansion interface (not shown), which may include, for example, a SIMM (Single In Line Memory Module) card interface. Such expansion memory may provide extra storage space for endpoint device(s) 140 or may also store applications or other information therein. In some implementations, expansion memory may include instructions to carry out or supplement the processes described above and may include secure information also. For example, expansion memory may be provided as a security module for endpoint device(s) 140 and may be programmed with instructions that permit secure use of endpoint device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some implementations, the user may use the endpoint device(s) 140 to transmit and/or receive information or commands to and from the system 130 via the network 110. Any communication between the system 130 and the endpoint device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the endpoint device(s) 140 may provide the system 130 (or other client devices) permissioned access to the protected resources of the endpoint device(s) 140, which may include a GPS device, an image capturing component (e.g., camera), a microphone, and/or a speaker.

The endpoint device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to endpoint device(s) 140, which may be used as appropriate by applications running thereon, and in some implementations, one or more applications operating on the system 130.

The endpoint device(s) 140 may also communicate audibly using audio codec 162, which may receive spoken information from a user and convert the spoken information to usable digital information. Audio codec 162 may likewise generate audible sound for a user, such as through a speaker, e.g., in a handset of endpoint device(s) 140. Such sound may include sound from voice telephone calls, may include recorded sound (e.g., voice messages, music files, etc.) and may also include sound generated by one or more applications operating on the endpoint device(s) 140, and in some implementations, one or more applications operating on the system 130.

Various implementations of the distributed computing environment 100, including the system 130 and endpoint device(s) 140, and techniques described here can be realized in digital electronic circuitry, integrated circuitry, specially designed ASICs (application specific integrated circuits), computer hardware, firmware, software, and/or combinations thereof.

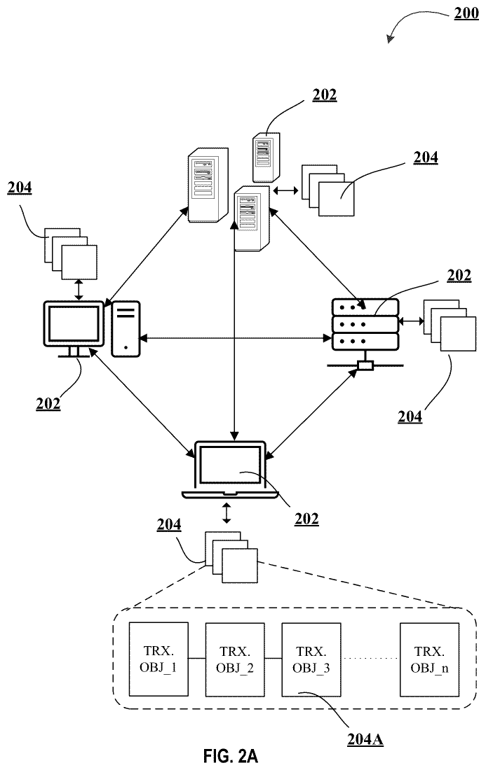

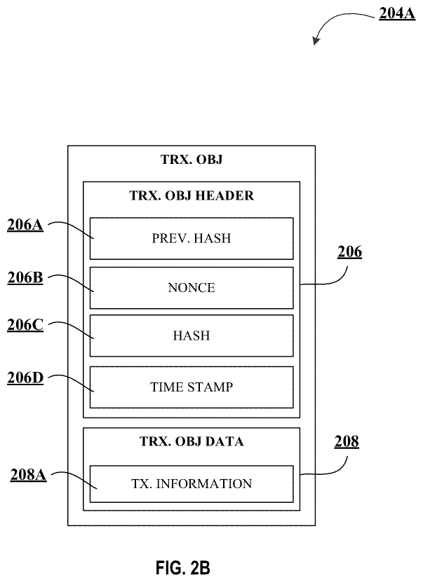

FIGS. 2A-2B illustrate an exemplary distributed ledger technology (DLT) architecture, in accordance with an implementation of the disclosure. DLT may refer to the protocols and supporting infrastructure that allow computing devices (peers) in different locations to propose and validate transactions and update records in a synchronized way across a network. Accordingly, DLT is based on a decentralized model, in which these peers collaborate and build trust over the network. To this end, DLT involves the use of potentially peer-to-peer protocol for a cryptographically secured distributed ledger of transactions represented as transaction objects that are linked. As transaction objects each contain information about the transaction object previous to it, they are linked with each additional transaction object, reinforcing the ones before it. Therefore, distributed ledgers are resistant to modification of their data because once recorded, the data in any given transaction object cannot be altered retroactively without altering all subsequent transaction objects.

To permit transactions and agreements to be carried out among various peers without the need for a central authority or external enforcement mechanism, DLT uses smart contracts. Smart contracts are computer code that automatically executes all or parts of an agreement and is stored on a DLT platform. The code can either be the sole manifestation of the agreement between the parties or might complement a traditional text-based contract and execute certain provisions, such as transferring funds from Party A to Party B. The code itself is replicated across multiple nodes (peers) and, therefore, benefits from the security, permanence, and immutability that a distributed ledger offers. That replication also means that as each new transaction object is added to the distributed ledger, the code is, in effect, executed. If the parties have indicated, by initiating a transaction, that certain parameters have been met, the code will execute the step triggered by those parameters. If no such transaction has been initiated, the code will not take any steps.

Various other specific-purpose implementations of distributed ledgers have been developed. These include distributed domain name management, decentralized crowd-funding, synchronous/asynchronous communication, decentralized real-time ride sharing and even a general purpose deployment of decentralized applications. In some implementations, a distributed ledger may be characterized as a public distributed ledger, a consortium distributed ledger, or a private distributed ledger. A public distributed ledger is a distributed ledger that anyone in the world can read, anyone in the world can send transactions to and expect to see them included if they are valid, and anyone in the world can participate in the consensus process for determining which transaction objects get added to the distributed ledger and what the current state each transaction object is. A public distributed ledger is generally considered to be fully decentralized. On the other hand, fully private distributed ledger is a distributed ledger whereby permissions are kept centralized with one entity. The permissions may be public or restricted to an arbitrary extent. And lastly, a consortium distributed ledger is a distributed ledger where the consensus process is controlled by a pre-selected set of nodes; for example, a distributed ledger may be associated with a number of member institutions (say 15), each of which operate in such a way that the at least 10 members must sign every transaction object in order for the transaction object to be valid. The right to read such a distributed ledger may be public or restricted to the participants. These distributed ledgers may be considered partially decentralized.

As shown in FIG. 2A, the exemplary DLT architecture 200 includes a distributed ledger 204 being maintained on multiple devices (nodes) 202 that are authorized to keep track of the distributed ledger 204. For example, these nodes 202 may be computing devices such as system 130 and client device(s) 140. One node 202 in the DLT architecture 200 may have a complete or partial copy of the entire distributed ledger 204 or set of transactions and/or transaction objects 204A on the distributed ledger 204. Transactions are initiated at a node and communicated to the various nodes in the DLT architecture. Any of the nodes can validate a transaction, record the transaction to its copy of the distributed ledger, and/or broadcast the transaction, its validation (in the form of a transaction object) and/or other data to other nodes.

As shown in FIG. 2B, an exemplary transaction object 204A may include a transaction header 206 and a transaction object data 208. The transaction header 206 may include a cryptographic hash of the previous transaction object 206A, a nonce 206B-a randomly generated 32-bit whole number when the transaction object is created, cryptographic hash of the current transaction object 206C wedded to the nonce 206B, and a time stamp 206D. The transaction object data 208 may include transaction information 208A being recorded. Once the transaction object 204A is generated, the transaction information 208A is considered signed and forever tied to its nonce 206B and hash 206C. Once generated, the transaction object 204A is then deployed on the distributed ledger 204. At this time, a distributed ledger address is generated for the transaction object 204A, i.e., an indication of where it is located on the distributed ledger 204 and captured for recording purposes. Once deployed, the transaction information 208A is considered recorded in the distributed ledger 204.

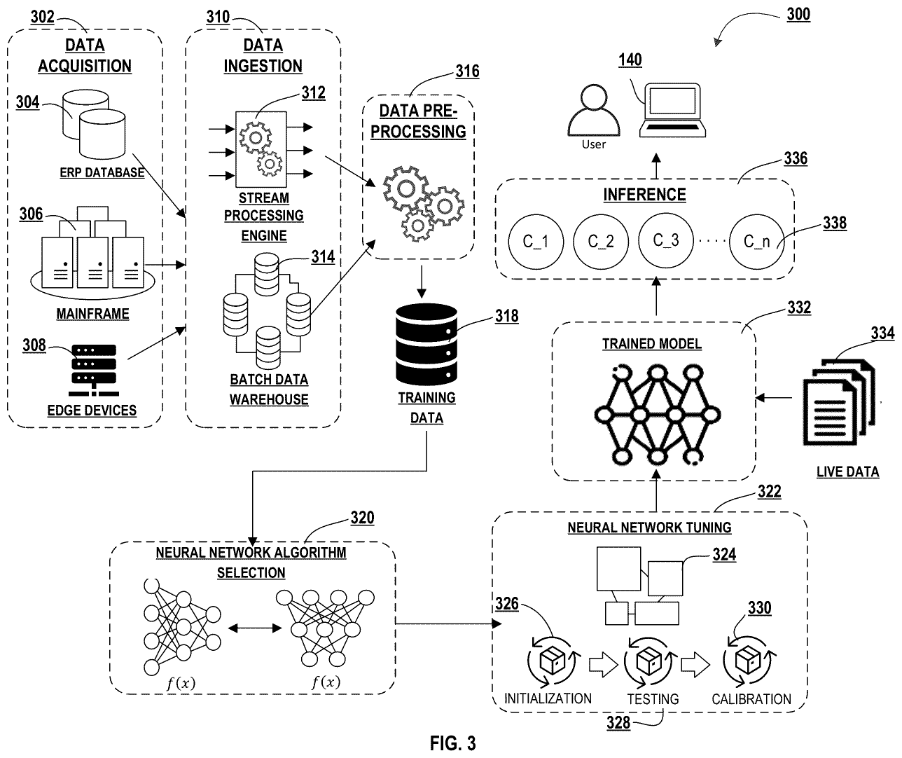

FIG. 3 illustrates an exemplary neural network subsystem architecture 300, in accordance with an implementation of the disclosure. The machine learning subsystem 300 may include a data acquisition engine 302, data ingestion engine 310, data pre-processing engine 316, neural network tuning engine 322, and inference engine 336.

The data acquisition engine 302 may identify various internal and/or external data sources to generate, test, and/or integrate new features for training the neural network 324. These internal and/or external data sources 304, 306, and 308 may be initial locations where the data originates or where physical information is first digitized. The data acquisition engine 302 may identify the location of the data and describe connection characteristics for access and retrieval of data. In some implementations, data is transported from each data source 304, 306, or 308 using any applicable network protocols, such as the File Transfer Protocol (FTP), Hyper-Text Transfer Protocol (HTTP), or any of the myriad Application Programming Interfaces (APIs) provided by websites, networked applications, and other services. In some implementations, the these data sources 304, 306, and 308 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 302 from these data sources 304, 306, and 308 may then be transported to the data ingestion engine 310 for further processing.

Depending on the nature of the data imported from the data acquisition engine 302, the data ingestion engine 310 may move the data to a destination for storage or further analysis. Typically, the data imported from the data acquisition engine 302 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 302, the data may be ingested in real-time, using the stream processing engine 312, in batches using the batch data warehouse 314, or a combination of both. The stream processing engine 312 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 314 collects and transfers data in batches according to scheduled intervals, trigger events, or any other logical ordering.

In machine learning, the quality of data and the useful information that can be derived therefrom directly affects the ability of the neural network 324 to learn. The data pre-processing engine 316 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 316 may implement feature extraction and/or selection techniques to generate training data 318. Feature extraction and/or selection is a process of dimensionality reduction by which an initial set of data is reduced to more manageable groups for processing. A characteristic of these large data sets is a large number of variables that require a lot of network resources to process. Feature extraction and/or selection may be used to select and/or combine variables into features, effectively reducing the amount of data that must be processed, while still accurately and completely describing the original data set. Depending on the type of machine learning algorithm being used, this training data 318 may require further enrichment. For example, in supervised learning, the training data is enriched using one or more meaningful and informative labels to provide context so a neural network can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

As will be understood in view of the present disclosure, training data 318 may additionally, or alternatively, be provided from a third party, having been generated as synthetic data.

The neural network tuning engine 322 may be used to train a neural network to form a trained neural network 324 using the training data 318 to make predictions or decisions without explicitly being programmed to do so. The neural network 324 represents what was learned by the selected machine learning algorithm 320 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the neural network, the neural network tuning engine 322 may repeatedly execute cycles of experimentation 326, testing 328, and tuning 330 to optimize the performance of the machine learning algorithm 320 and refine the results in preparation for deployment of those results for consumption or decision making. To this end, the neural network tuning engine 322 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 318. A fully trained neural network 332 is one whose hyperparameters are tuned and model accuracy maximized.

The trained neural network 332 (which may include first and second primary neural networks, first and second secondary neural networks, tertiary neural networks, and so forth, as will be described in detail herein), similar to any other software application output, can be persisted to storage, file, memory, or application, or looped back into the processing component to be reprocessed. More often, the trained neural network 332 is deployed into an existing production environment to make practical business decisions based on live data 334. To this end, the machine learning subsystem 300 uses the inference engine 336 to make such decisions. The type of decision-making may depend upon the type of machine learning algorithm used. For example, neural networks trained using supervised learning algorithms may be used to structure computations in terms of categorized outputs (e.g., C_1, C_2 . . . . C_n 338) or observations based on defined classifications, represent possible solutions to a decision based on certain conditions, model complex relationships between inputs and outputs to find patterns in data or capture a statistical structure among variables with unknown relationships, and/or the like. On the other hand, neural networks trained using unsupervised learning algorithms may be used to group (e.g., C_1, C_2 . . . . C_n 338) live data 334 based on how similar they are to one another to solve exploratory challenges where little is known about the data, provide a description or label (e.g., C_1, C_2 . . . . C_n 338) to live data 334, such as in classification, and/or the like. These categorized outputs, groups (clusters), or labels are then presented to the user input system 130. In still other cases, neural networks that perform regression techniques may use live data 334 to predict or forecast continuous outcomes.

It shall be understood that the implementation of the machine learning subsystem 300 illustrated in FIG. 3 is exemplary and that other implementations may vary. As another example, in some implementations, the machine learning subsystem 300 may include more, fewer, or different components.

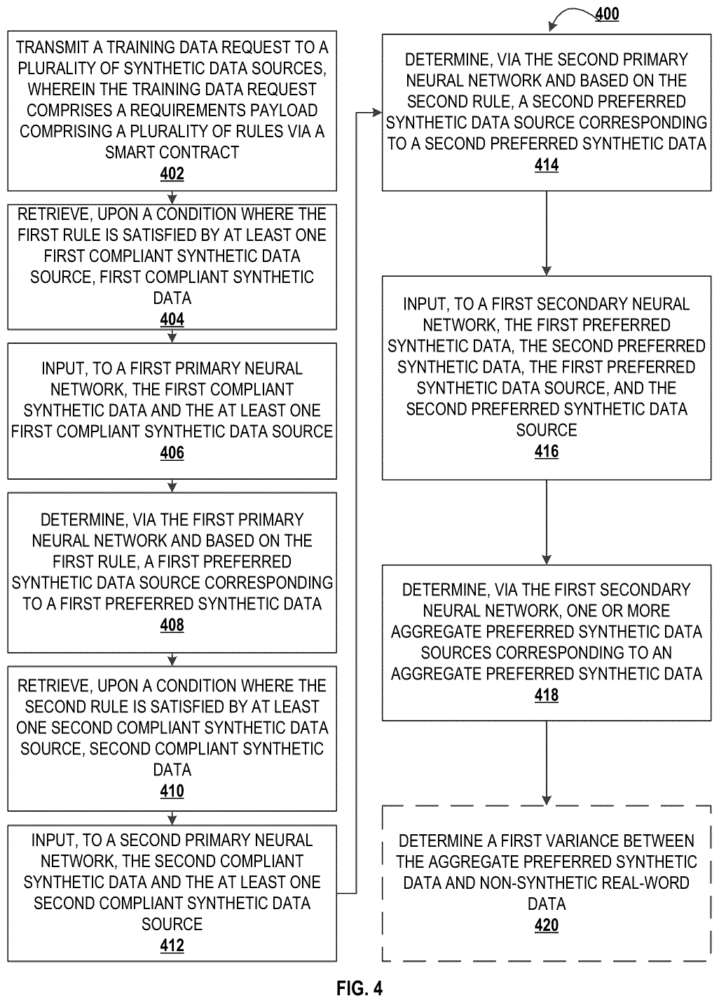

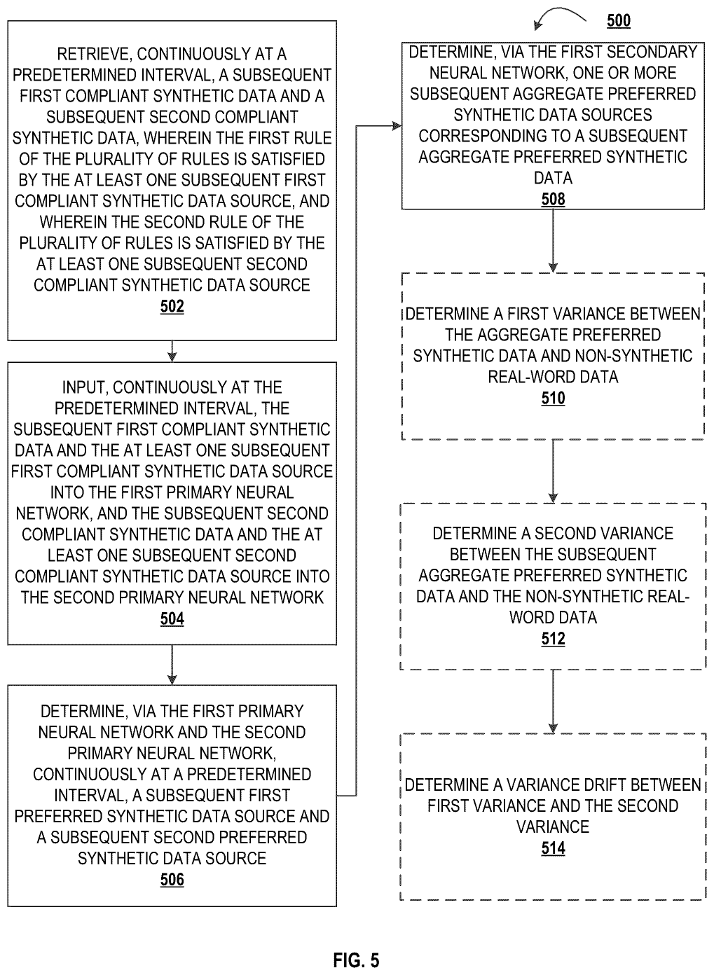

FIGS. 4 and 5 illustrate a process flow for targeted synthetic data extraction and analysis via a multi-modal neural network, in accordance with an implementation of the disclosure. Initially, at block 402, the system 130 may transmit a training data request. Specifically, the training data request may include a request for training data that includes synthetic data. Such synthetic data may be used for training a machine learning model by the entity. The training data request may be transmitted to a plurality of synthetic data sources, for example, multiple vendors of synthetic data that may provide the synthetic data to the entity.

Additionally, or alternatively, the training data request may be transmitted to synthetic data distribution organizations within an entity, such that synthetic data may be provided to a group within the entity by other portions of the entity or evaluated against synthetic data of third parties.

The training data request may include a requirements payload, such as to indicate to the synthetic data sources the requirements or specifications for the synthetic data. The requirements payload may include a plurality of rules that are set forth in a smart contract of the distributed ledger. The smart contract may be self-executing and reside on a blockchain or other types of distributed ledgers as described with respect to FIGS. 2A and 2B. As such, an infrastructure is implemented that only allows for the synthetic data source(s) to further communicate their synthetic data (e.g., transmit/receive) if it complies with certain requirements set forth by the entity in the smart contract of the training data request.

The types of rules set forth may include various requirements. For example, a plurality of rules may be set forth in the smart contract, including requirements for the data temporal information, requirements for synthetic data geolocation, requirements for the synthesizing algorithm name, and/or requirements for the synthesizing algorithm version. Additionally, a target variance from non-synthetic real-world data may be specified in the rules.

Regarding requirements for the synthetic data temporal information, these requirements often include timestamps indicating when data was collected or updated, intervals for data aggregation, and historical data for trend analysis. For instance, in financial markets, stock prices require real-time timestamps to track market fluctuations, historical data for trend analysis, and intervals for calculating moving averages or volatility. Accordingly, the synthetic data temporal information requirements may specify that only synthetic data between a first date and/or time and a second date and/or time should be included.

Regarding requirements for synthetic data geolocation, these requirements typically include latitude and longitude coordinates, accuracy metrics, and/or timestamps indicating when the location was recorded. For instance, in logistics, real-time geolocation data with timestamps provides for accurate tracking of shipments, optimizing routes, and predicting delivery times. Accordingly, the synthetic data geolocation requirements may specify that only synthetic data collected in a predetermined geographical region should be included.

Regarding requirements for the synthesizing algorithm name, it shall be appreciated that the choice of algorithm for synthesizing data depends on the specific requirements of the task and the characteristics of the dataset. Some common algorithms for data synthesis include Generative Adversarial Networks (GANs), Variational Autoencoders (VAEs), and Differential Privacy mechanisms. For example, in generating synthetic images for training machine learning models, GANs are often used to produce realistic-looking data points that closely resemble the original dataset. Similarly, VAEs are used when there is a need to capture the underlying distribution of the data while preserving its structure. Accordingly, the synthetic data algorithm name requirement may specify the type of algorithm(s) used to originally synthesize the underlying synthetic data.

Regarding requirements for the synthesizing algorithm version, it shall be appreciated that differences as a result of newer or older algorithm versions may provide for differing qualities of synthetic data. For example, with respect to GANs, newer versions like Progressive GANs provide improved capabilities in generating high-resolution images compared to earlier versions. Similarly, advancements in VAEs, such as Beta-VAE or Wasserstein Autoencoders, provide for improved capturing of complex data distributions. Accordingly, the synthetic data algorithm version requirement may specify the version number, release number, or name of the algorithm used to originally synthesize the underlying data.

Regarding requirements for a target variance, it shall be appreciated that in modeling, a target variance between synthetic data and real-world data may be as a measure of how closely the synthetic data mirrors the actual data it represents. This variance may be expressed as a percentage. For example, in a financial setting, synthetic stock price data may be generated. To ensure the synthetic data reflects the volatility and trends observed in real stock prices, the data generation process might involve statistical analysis of historical price movements, incorporation of market factors such as interest rates and economic indicators, and the use of stochastic processes to simulate future price changes. Synthetic data sources may adjust parameters and fine-tuning the generation process to a target variance set forth in the smart contract. For example, the target variance may be 10% or less, 5% or less, 1% or less, etc. meaning that the synthetic data should closely match the statistical characteristics of the actual stock price data within this margin. Alternatively, the smart contract may provide for the analysis of real-world data and the given synthetic data in an extrinsic manner through oracle integration, such that the synthetic data and the real-word data can be compared, and a variance calculated. An oracle may act as bridge between the blockchain where the smart contract resides and external database(s) of real-world data and the synthetic data. The smart contract may interact with the oracle to fetch this external data and perform the calculation of variance therebetween.

Indeed, the smart contract may have one rule, or two rules, or any number of rules. As used herein, however, reference will be made to a smart contract only having a first rule and a second rule, for purposes of brevity. As will be understood in view of the present disclosure, each rule will correspond to a unimodal neural network. As such, smart contracts having more rules will be associated with more unimodal neural networks, which leads to a larger network of unimodal neural networks for implementation into a multi-modal network as a whole.

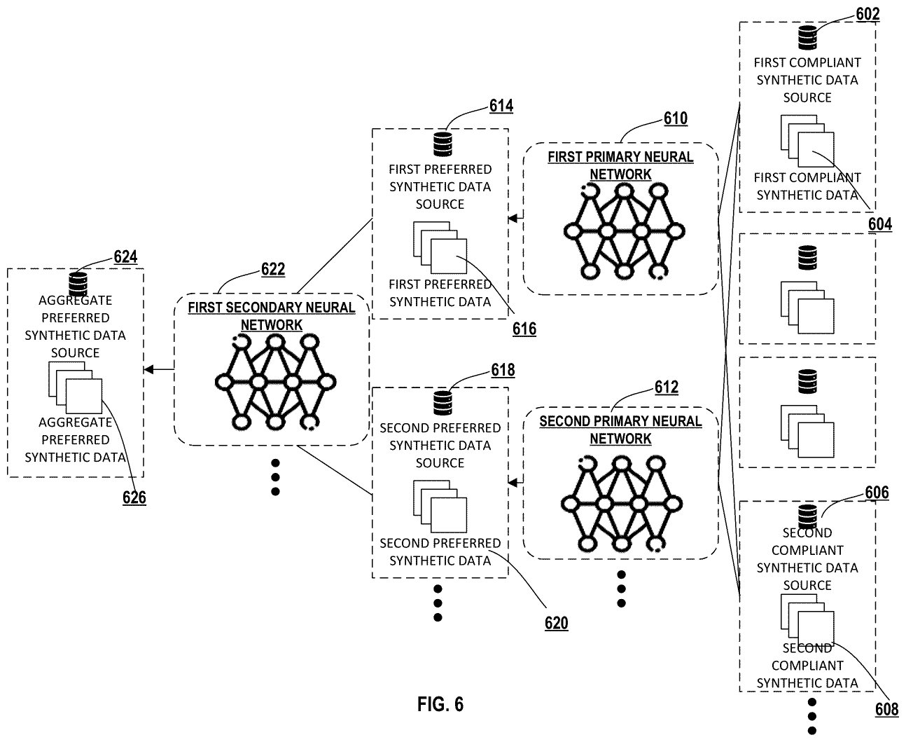

Henceforth, while the process flow will continue to be described with respect to FIGS. 4 and 5, reference may also be made to components of FIG. 6. FIG. 6 illustrates a network diagram of a neural network layers of a multimodal neural network, in accordance with some implementations of the disclosure.

Proceeding now to block 404, the system 130 may retrieve synthetic data (i.e., first compliant synthetic data 604) that satisfies a rule (i.e., the first rule). Alternatively, the synthetic data that satisfies a rule may be transmitted to the system 130 as a result of satisfying the rule. Additionally, or alternatively, the synthetic data itself may not be transmitted or received, rather metadata regarding the location(s) (i.e., the synthetic data source) of the synthetic data may be transmitted or received. Indeed, as used herein, “synthetic data” may refer to either the data itself or refer to the location thereof.

The synthetic data that satisfies the rule may originate at a single synthetic data source (i.e., the first compliant synthetic data source 602), or multiple synthetic data sources, each providing first compliant synthetic data 604 that satisfies the first rule.

Next, at block 406, the system 130 may input to a neural network (i.e., a first primary neural network 610) the first compliant synthetic data 604 and the at least one first compliant synthetic data source 602. The first primary neural network 610 may be one neural network of a series of neural networks in the “primary” layer of a multi-modal neural network. The “primary layer” may refer to the plurality of unimodal “primary” neural networks, each receiving synthetic data and the synthetic data source based on a singular rule defined in the smart contract. As will be appreciated in view of this disclosure, the outputs from the plurality of primary neural networks feeds at least one secondary neural network 622 in a secondary layer.

Continuing now at block 408, the system 130 may determine, via the first primary neural network 610 and based on the first rule, a first preferred synthetic data source 614 corresponding to a first preferred synthetic data 616. In implementations where the synthetic data that satisfies the rule originates from only single synthetic data source (i.e., the first compliant synthetic data source 602), the neural network may simply determine that the preferred synthetic data as it pertains to the rule is the identified only single synthetic data source (i.e., the first compliant synthetic data source 602).

Alternatively, in implementations where multiple synthetic data sources each have compliant synthetic data that satisfies the first rule, the first primary neural network 610 receives multiple first compliant synthetic data 604. The first primary neural network 610 may then determine an ideal synthetic data and its corresponding synthetic data source. To do so, the first primary neural network 610 may evaluate the quality and relevance of each synthetic data sample based on predefined criteria or objectives. This evaluation can involve assessing factors such as similarity to real data distribution, fidelity in representing underlying patterns, and usefulness for the intended task or application. Additionally, or alternatively, the first primary neural network 610 may consider metadata associated with each synthetic data source, such as the reliability of the generating algorithm, the diversity of the generated samples, etc. Additionally, or alternatively, the first primary neural network 610 may consider how closely the first compliant synthetic data 604 comports with the first rule. For example, one first compliant synthetic data 604 may have a variance with real-world data of 5%, while another first compliant synthetic data 604 may have a variance with real-world data of 2%. In such an instance, the first primary neural network 610 would have been trained to identify the lowest variance, and thus select the latter of the two first compliant synthetic data 604 as the first preferred synthetic data 616.

Proceeding now to block 410, the system 130 may retrieve additional synthetic data (i.e., second compliant synthetic data 608) that satisfies a rule (i.e., the second rule). Alternatively, the synthetic data that satisfies a rule may be transmitted to the system 130 as a result of satisfying the rule. Additionally, or alternatively, the synthetic data itself may not be transmitted or received, rather metadata regarding the location(s) (i.e., the synthetic data source) of the synthetic data may be transmitted or received.

The synthetic data that satisfies the rule may originate at a single synthetic data source (i.e., the second compliant synthetic data source 606), or multiple synthetic data sources, each providing second compliant synthetic data 608 that satisfies the second rule.

Next, at block 412, the system 130 may input to a neural network (i.e., a second primary neural network 612) the second compliant synthetic data 608 and the at least one second compliant synthetic data source 606. The second primary neural network 612 may be one neural network of a series of neural networks in the “primary” layer of a multi-modal neural network.

Continuing now at block 414, the system 130 may determine, via the second primary neural network 612 and based on the second rule, a second preferred synthetic data source 618 corresponding to a second preferred synthetic data 620. In implementations where the synthetic data that satisfies the rule originates from only single synthetic data source (i.e., the second compliant synthetic data source 606), the neural network may simply determine that the preferred synthetic data as it pertains to the rule is the identified only single synthetic data source (i.e., the second compliant synthetic data source 606).

Alternatively, in implementations where multiple synthetic data sources each have compliant synthetic data that satisfies the second rule, the second primary neural network 612 receives multiple second compliant synthetic data 608. The second primary neural network 612 may then determine an ideal synthetic data and its corresponding synthetic data source. To do so, the second primary neural network 612 may evaluate the quality and relevance of each synthetic data sample based on predefined criteria or objectives. This evaluation can involve assessing factors such as similarity to real data distribution, fidelity in representing underlying patterns, and usefulness for the intended task or application. Additionally, or alternatively, the second primary neural network 612 may consider metadata associated with each synthetic data source, such as the reliability of the generating algorithm, the diversity of the generated samples, etc. Additionally, or alternatively, the second primary neural network 612 may consider how closely the second compliant synthetic data 608 comports with the second rule. For example, one second compliant synthetic data 608 may have a variance with real-world data of 5%, while another second compliant synthetic data 608 may have a variance with real-world data of 2%. In such an instance, the second primary neural network 612 would have been trained to identify the lowest variance, and thus select the latter of the two second compliant synthetic data 608 as the second preferred synthetic data 620.

Next, at block 416, the system 130 may input to a first secondary neural network 622 of at least one secondary neural network, the outputs from the first and second primary neural network 612s (i.e., the first preferred synthetic data 616, the second preferred synthetic data 620, the first preferred synthetic data source 614, and the second preferred synthetic data source 618). Since each of the primary neural networks corresponds to a rule from the smart contract, it shall be appreciated that further analysis is required of the outputs of such primary neural networks to balance predetermined competing factors and ultimately arrive at a synthetic data source(s) and training data that represent the entity's interests.

Put a different way, the outputs of at least two separate neural networks (primary neural networks) being implemented as inputs to at least one third neural network (secondary neural network 622), provides for the use of complementary information inherent in each network's learned representations. The aggregation of outputs allows for the secondary neural network model to benefit from the feature representations captured by each primary network, which helps overcome the limitations of individual network architectures. This technique resembles ensemble learning, where combining knowledge from multiple models enhances overall predictive capability. Further, by adjusting the weighting mechanisms controlling the contribution of each primary network's output, the method provides for an agglomeration of information, improvements in dataset performance metrics such as accuracy and generalization.

Importantly, the outputs of neural networks at the primary neural network level being combined at the secondary neural network 622 level allows for the analysis of various types and formats of data, such that the overall structure is multi-modal, with each of the primary neural networks developed to receive data of a particular type which may be unique from that of other primary neural networks. For example, one primary neural network may specialize in processing visual data from images or videos, while another may focus on textual data from documents or online sources. Additionally, or alternatively, another primary neural network might be tailored for handling numerical or sensor data, such as from IoT devices or scientific instruments.

Next, at block 418, the system 130 may determine one or more aggregate preferred synthetic data sources 624 corresponding to an aggregate preferred synthetic data 626. This determination may be performed via the first secondary neural network 622. As used herein, an “aggregate preferred synthetic data” may refer to the synthetic data identified by the multi-modal neural network (i.e., the secondary neural network(s) receiving the outputs of the primary neural networks as inputs) to be most ideal for use by the entity. Further, as used herein, an “aggregate preferred synthetic data source” is one or more synthetic data sources identified to provide this aggregate preferred synthetic data 626.

In implementations where the synthetic data identified by each of the primary neural networks originates from only single synthetic data source, the secondary neural network 622 may simply determine that the aggregate preferred synthetic data 626 and the aggregate preferred synthetic data source 624 is the identified only single synthetic data source.

Alternatively, in implementations where multiple synthetic data sources each have each been identified by the primary neural networks, the secondary neural network 622 receives first and second preferred synthetic data 620. The secondary neural network 622 may then determine an aggregate preferred synthetic data 626 and its corresponding aggregate preferred synthetic data source 624. To do so, the secondary neural network 622 may evaluate the quality and relevance of each synthetic data sample based on predefined criteria or objectives. This evaluation can involve assessing factors such as similarity to real data distribution, fidelity in representing underlying patterns, and usefulness for the intended task or application. Additionally, or alternatively, the secondary neural network 622 may consider metadata associated with each synthetic data source, such as the reliability of the generating algorithm, the diversity of the generated samples, etc. For example, the first preferred synthetic data 616 may have a variance with real-world data of 5%, while the second preferred synthetic data 620 may have a variance with real-world data of 2%. Despite the second preferred synthetic data 620 having been identified by a primary neural network based on other factors (such as a different rule), both the first and second preferred synthetic data 616, 620 may be analyzed based on this variance rule (and/or other rules) to determine an aggregate preferred training data that best suits the rules as a whole, even if the aggregate preferred training data is not the preferred training data based on a single rule.

At block 420, the system 130 may determine a first variance between the aggregate preferred synthetic data 626 and non-synthetic real-word data. This first variance may be a measure of how closely the aggregate preferred training data mirrors the actual data (i.e., non-synthetic real-world data) it represents. This variance may be expressed as a percentage. For example, the aggregate preferred synthetic data 626 may represent interest rates for various categories of consumers. To evaluate if the aggregate preferred synthetic data 626 reflects the volatility and trends observed in real interest rates, a first variance may be 10% or less, 5% or less, 1% or less, etc. meaning that the aggregate preferred synthetic data 626, when averaged per capita for each person to which it is related within the aggregate preferred synthetic data 626, should match the statistical characteristics of actual interest rate data, per capita, on average, within this margin.

Continuing at FIG. 5, the process may proceed at block 502. The process outlined with respect to FIG. 5 embraces an ongoing analysis of the quality of synthetic data over time, such as to continuously monitor synthetic data and its sources. In doing so, the system 130 re-evaluates the synthetic data and sources thereof at a predetermined interval to determine if any other synthetic data or sources thereof better meet the requirements of the entity, as set forth in the rules of the smart contract. Additionally, or alternatively, the system 130 may track “drift” in various parameters, including any changes in variance between the synthetic data and non-synthetic real-world data. The processes involved in such activities resemble those in FIG. 4, however they may occur on a recurring basis at a predetermined time interval.

Accordingly, the system 130 may retrieve, continuously at a predetermined interval, a subsequent first compliant synthetic data 604 from at least one subsequent first compliant synthetic data source 602. The system 130 may also retrieve a subsequent second compliant synthetic data 608 from at least one subsequent second compliant synthetic data source 606. In some implementations, the predetermined interval may be daily. In other implementations, the predetermined interval may be 1 hour, 1 day, 1 week, 1 month, 1 year, and so forth.

In some implementations, for purposes of tracking a known synthetic data and source, the subsequent first compliant synthetic data source 602 may be selected to be identical to the first compliant synthetic data source 602, and the subsequent second compliant synthetic data source 606 may be selected to be identical to the second compliant synthetic data source 606.

In other implementations, the process may begin at the beginning, where a plurality of otherwise unrelated synthetic data sources and their data are evaluated as a result of their compliance with the rules in the smart contract, even if said synthetic data sources and their corresponding data did not previously comply with said rules. In this way, a process similar to that of blocks 404 and 410 in FIG. 4 may occur, where in such implementations, subsequent first compliant synthetic data 604 is received from at least one subsequent first compliant synthetic data source 602 based on satisfaction of the first rule of the plurality of rules. Similarly, subsequent second compliant synthetic data 608 is received from at least one subsequent second compliant synthetic data source 606 based on satisfaction of the second rule of the plurality of rules.

Continuing at block 504, in a manner similar to that which was described with respect to blocks 406 and 412, the system 130 may input, continuously at the predetermined interval, the subsequent first compliant synthetic data 604 and the at least one subsequent first compliant synthetic data source 602 into the first primary neural network 610. The system 130 may also input the subsequent second compliant synthetic data 608 and the at least one subsequent second compliant synthetic data source 606 into the second primary neural network 612. At block 506, in a manner similar to that which was described with respect to blocks 408 and 414, the system 130 may determine, via the first primary neural network 610 and the second primary neural network 612, continuously at a predetermined interval, a subsequent first preferred synthetic data source 614 and a subsequent second preferred synthetic data source 618. Next, at block 508, and in a manner similar to that which was described with respect to block 418, the system 130 may determine, via the first secondary neural network 622, one or more subsequent aggregate preferred synthetic data sources 624 corresponding to a subsequent aggregate preferred synthetic data 626.

Referring now to block 510, it shall be appreciated that to analyze changes in variance, a baseline must be established. As such, the system 130 may determine (or retrieve, if previously determined) a first variance between the aggregate preferred synthetic data 626 and non-synthetic real-word data, an identical process for which was described with respect to block 420 using other inputs.

Accordingly, at block 512, in a manner similar to that which was described with respect to block 420, the system 130 may determine a second variance between the subsequent aggregate preferred synthetic data 626 and the non-synthetic real-word data. In this way, the differences between the first variance and the second variance may be calculated, plotted on a graph over time, and so forth, as is illustrated at block 514, where the system 130 determines a variance drift between first variance and the second variance.

In some implementations, the system 130 may send a notification to an endpoint device 140 under a condition where the variance drift is above a predetermined value. This notification may include an indicator of the synthetic data, the variance drift (in percentage form), and/or the source of the synthetic data.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other implementations of the present disclosure set forth herein will come to mind to one skilled in the art to which these implementations pertain having the benefit of the teachings presented in the foregoing descriptions and the associated drawings. Although the Figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A system for targeted synthetic data extraction and analysis via a multi-modal neural network, the system comprising:
a processing device;
a non-transitory storage device containing instructions when executed by the processing device, causes the processing device to perform the steps of:
transmit a training data request for training a machine learning model to a plurality of synthetic data sources, wherein the training data request comprises a requirements payload for synthetic data, the requirements payload comprising a plurality of rules via a smart contract, wherein the plurality of rules comprises a first rule and a second rule;
retrieve, upon a condition where the first rule is satisfied by at least one first compliant synthetic data source, first compliant synthetic data from the at least one first compliant synthetic data source;
input, to a first primary neural network of at least one primary neural network, the first compliant synthetic data and the at least one first compliant synthetic data source;
determine, via the first primary neural network and based on the first rule, a first preferred synthetic data source corresponding to a first preferred synthetic data;
retrieve, upon a condition where the second rule is satisfied by at least one second compliant synthetic data source, second compliant synthetic data from the at least one second compliant synthetic data source;
input, to a second primary neural network of the at least one primary neural network, the second compliant synthetic data and the at least one second compliant synthetic data source;
determine, via the second primary neural network and based on the second rule, a second preferred synthetic data source corresponding to a second preferred synthetic data;
input, to a first secondary neural network of at least one secondary neural network, the first preferred synthetic data, the second preferred synthetic data, the first preferred synthetic data source, and the second preferred synthetic data source; and
determine, via the first secondary neural network, one or more aggregate preferred synthetic data sources corresponding to an aggregate preferred synthetic data.

2. The system of claim 1, wherein the instructions further cause the processing device to perform the steps of:
retrieve, continuously at a predetermined interval, a subsequent first compliant synthetic data from at least one subsequent first compliant synthetic data source, and a subsequent second compliant synthetic data from at least one subsequent second compliant synthetic data source, wherein the first rule of the plurality of rules is satisfied by the at least one subsequent first compliant synthetic data source, and wherein the second rule of the plurality of rules is satisfied by the at least one subsequent second compliant synthetic data source;
input, continuously at the predetermined interval, the subsequent first compliant synthetic data and the at least one subsequent first compliant synthetic data source into the first primary neural network, and the subsequent second compliant synthetic data and the at least one subsequent second compliant synthetic data source into the second primary neural network;
determine, via the first primary neural network and the second primary neural network, continuously at a predetermined interval, a subsequent first preferred synthetic data source and a subsequent second preferred synthetic data source; and
determine, via the first secondary neural network, one or more subsequent aggregate preferred synthetic data sources corresponding to a subsequent aggregate preferred synthetic data.

3. The system of claim 1, wherein the instructions further cause the processing device to perform the steps of:
determine a first variance between the aggregate preferred synthetic data and non-synthetic real-word data.

4. The system of claim 2, wherein the instructions further cause the processing device to perform the steps of:
determine a first variance between the aggregate preferred synthetic data and non-synthetic real-word data;
determine a second variance between the subsequent aggregate preferred synthetic data and the non-synthetic real-word data; and
determine a variance drift between first variance and the second variance.

5. The system of claim 1, wherein the plurality of rules comprises at least one selected from the group consisting of synthetic data temporal information, synthetic data geolocation, synthesizing algorithm name, and synthesizing algorithm version.

6. The system of claim 1, wherein the plurality of rules comprises a target variance from non-synthetic real-world data.

7. The system of claim 1, wherein the smart contract is self-executing and resides on a blockchain.

8. A computer program product for targeted synthetic data extraction and analysis via a multi-modal neural network, the computer program product comprising a non-transitory computer-readable medium comprising code causing an apparatus to:
transmit a training data request for training a machine learning model to a plurality of synthetic data sources, wherein the training data request comprises a requirements payload for synthetic data, the requirements payload comprising a plurality of rules via a smart contract, wherein the plurality of rules comprises a first rule and a second rule;
retrieve, upon a condition where the first rule is satisfied by at least one first compliant synthetic data source, first compliant synthetic data from the at least one first compliant synthetic data source;
input, to a first primary neural network of at least one primary neural network, the first compliant synthetic data and the at least one first compliant synthetic data source;
determine, via the first primary neural network and based on the first rule, a first preferred synthetic data source corresponding to a first preferred synthetic data;
retrieve, upon a condition where the second rule is satisfied by at least one second compliant synthetic data source, second compliant synthetic data from the at least one second compliant synthetic data source;
input, to a second primary neural network of the at least one primary neural network, the second compliant synthetic data and the at least one second compliant synthetic data source;
determine, via the second primary neural network and based on the second rule, a second preferred synthetic data source corresponding to a second preferred synthetic data;
input, to a first secondary neural network of at least one secondary neural network, the first preferred synthetic data, the second preferred synthetic data, the first preferred synthetic data source, and the second preferred synthetic data source; and
determine, via the first secondary neural network, one or more aggregate preferred synthetic data sources corresponding to an aggregate preferred synthetic data.

9. The computer program product of claim 8, wherein the code further causes the apparatus to:
retrieve, continuously at a predetermined interval, a subsequent first compliant synthetic data from at least one subsequent first compliant synthetic data source, and a subsequent second compliant synthetic data from at least one subsequent second compliant synthetic data source, wherein the first rule of the plurality of rules is satisfied by the at least one subsequent first compliant synthetic data source, and wherein the second rule of the plurality of rules is satisfied by the at least one subsequent second compliant synthetic data source;
input, continuously at the predetermined interval, the subsequent first compliant synthetic data and the at least one subsequent first compliant synthetic data source into the first primary neural network, and the subsequent second compliant synthetic data and the at least one subsequent second compliant synthetic data source into the second primary neural network;
determine, via the first primary neural network and the second primary neural network, continuously at a predetermined interval, a subsequent first preferred synthetic data source and a subsequent second preferred synthetic data source; and
determine, via the first secondary neural network, one or more subsequent aggregate preferred synthetic data sources corresponding to a subsequent aggregate preferred synthetic data.

10. The computer program product of claim 8, wherein the code further causes the apparatus to:
determine a first variance between the aggregate preferred synthetic data and non-synthetic real-word data.

11. The computer program product of claim 9, wherein the code further causes the apparatus to:
determine a first variance between the aggregate preferred synthetic data and non-synthetic real-word data;
determine a second variance between the subsequent aggregate preferred synthetic data and the non-synthetic real-word data; and
determine a variance drift between first variance and the second variance.

12. The computer program product of claim 8, wherein the plurality of rules comprises at least one selected from the group consisting of synthetic data temporal information, synthetic data geolocation, synthesizing algorithm name, and synthesizing algorithm version.

13. The computer program product of claim 8, wherein the plurality of rules comprises a target variance from non-synthetic real-world data.

14. The computer program product of claim 8, wherein the smart contract is self-executing and resides on a blockchain.

15. A method for targeted synthetic data extraction and analysis via a multi-modal neural network, the method comprising:
transmitting a training data request for training a machine learning model to a plurality of synthetic data sources, wherein the training data request comprises a requirements payload for synthetic data, the requirements payload comprising a plurality of rules via a smart contract, wherein the plurality of rules comprises a first rule and a second rule;
retrieving, upon a condition where the first rule is satisfied by at least one first compliant synthetic data source, first compliant synthetic data from the at least one first compliant synthetic data source;
inputting, to a first primary neural network of at least one primary neural network, the first compliant synthetic data and the at least one first compliant synthetic data source;
determining, via the first primary neural network and based on the first rule, a first preferred synthetic data source corresponding to a first preferred synthetic data;
retrieving, upon a condition where the second rule is satisfied by at least one second compliant synthetic data source, second compliant synthetic data from the at least one second compliant synthetic data source;
inputting, to a second primary neural network of the at least one primary neural network, the second compliant synthetic data and the at least one second compliant synthetic data source;
determining, via the second primary neural network and based on the second rule, a second preferred synthetic data source corresponding to a second preferred synthetic data;
inputting, to a first secondary neural network of at least one secondary neural network, the first preferred synthetic data, the second preferred synthetic data, the first preferred synthetic data source, and the second preferred synthetic data source; and
determining, via the first secondary neural network, one or more aggregate preferred synthetic data sources corresponding to an aggregate preferred synthetic data.

16. The method of claim 15, further comprising:
retrieving, continuously at a predetermined interval, a subsequent first compliant synthetic data from at least one subsequent first compliant synthetic data source, and a subsequent second compliant synthetic data from at least one subsequent second compliant synthetic data source, wherein the first rule of the plurality of rules is satisfied by the at least one subsequent first compliant synthetic data source, and wherein the second rule of the plurality of rules is satisfied by the at least one subsequent second compliant synthetic data source;
inputting, continuously at the predetermined interval, the subsequent first compliant synthetic data and the at least one subsequent first compliant synthetic data source into the first primary neural network, and the subsequent second compliant synthetic data and the at least one subsequent second compliant synthetic data source into the second primary neural network;
determining, via the first primary neural network and the second primary neural network, continuously at a predetermined interval, a subsequent first preferred synthetic data source and a subsequent second preferred synthetic data source; and
determining, via the first secondary neural network, one or more subsequent aggregate preferred synthetic data sources corresponding to a subsequent aggregate preferred synthetic data.

17. The method of claim 15, further comprising:
determining a first variance between the aggregate preferred synthetic data and non-synthetic real-word data.

18. The method of claim 16, further comprising:
determining a first variance between the aggregate preferred synthetic data and non-synthetic real-word data;
determining a second variance between the subsequent aggregate preferred synthetic data and the non-synthetic real-word data; and
determining a variance drift between first variance and the second variance.

19. The method of claim 15, wherein the plurality of rules comprises at least one selected from the group consisting of synthetic data temporal information, synthetic data geolocation, synthesizing algorithm name, and synthesizing algorithm version.

20. The method of claim 15, wherein the plurality of rules comprises a target variance from non-synthetic real-world data.
